(19) United States
(12) Patent Application Publication
(10) Pub. No.: US 2024/0424465 A1
(43) Pub. Date: Dec. 26, 2024

(54) TUNABLE NANOSTRUCTURE FORMATION METHODS AND TECHNIQUES EXPLOITING ABLATION

(71) Applicant: RIAD NECHACHE, MONTREAL (CA)

(72) Inventor: RIAD NECHACHE, MONTREAL (CA)

(21) Appl. No.: 18/710,441

(22) PCT Filed: Nov. 15, 2022
(86) PCT No.: PCT/CA2022/051681

§ 371 Date: May 15, 2024

Related U.S. Application Data
(60) Provisional application No. 63/279,259, filed on Nov. 15, 2021.

(51) Int. Cl. B01J 13/04

(52) U.S. Cl. CPC B01J 13/04

(57) ABSTRACT

Nanoparticles have applications across medicine, physics, chemistry, biochemistry, agriculture, optics, electronics, renewable energy, textiles etc. Whilst several methods for creating nanoparticles, including inert gas condensation, attrition, chemical precipitation, ion implantation, radiolysis, pyrolysis and hydrothermal synthesis, exist these exhibit limitations. These limitations are exacerbated when considering coating processes of nanoparticles to generate core-shell nanoparticles. Accordingly, the invention provides a manufacturing methodology suitable for production of nanoparticles at a high yield whilst facilitating core-shell nanoparticles, core-shell nanoparticles with organic cores etc. and their related colloidal solutions and inks.

### CROSS-REFERENCE TO RELATED APPLICATIONS

This patent application claims the benefit of priority as a 371 National Phase Entry application of PCT/CA2022/051681 filed Nov. 15, 2022; which itself claims the benefit of priority to U.S. Patent Application 63/279,259 filed Nov. 15, 2021.

### FIELD OF THE INVENTION

This patent application relates to nanoparticles and inorganic colloidal solutions and more particularly to methods of manufacturing simple and complex nanoparticles using ablation processes.

### BACKGROUND OF THE INVENTION

Nanoparticles have an enormous range of potential and actual applications across medicine, physics, chemistry, biochemistry, agriculture, optics, electronics, renewable energy, textiles etc. There are several methods for creating nanoparticles, including inert gas condensation, attrition, chemical precipitation, ion implantation, radiolysis, pyrolysis and hydrothermal synthesis.

However, these methods all exhibit limitations particularly for the synthesis of nanoparticles with high yield and controlled dimensions and/or properties. These limitations are exacerbated when considering coating processes of nanoparticles to generated what are referred to a core-shell nanoparticles.

Accordingly, it would be beneficial to provide a manufacturing methodology suitable for production at high yield of nanoparticles and core-shell nanoparticles and their related colloidal solutions and inks.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to nanoparticles and more particularly to methods of manufacturing simple and complex nanoparticles and their related colloidal solutions using ablation processes.

In accordance with an embodiment of the invention there is provided a method of generating nanostructures and related colloidal solutions comprising:
providing a tube;
providing a target within the tube from which the nanostructures are to be formed;
providing an ablation source for generating pulses that ablate the target to form the nanostructures;
providing a first fluid within the tube;
directing the pulses from the ablation source to the target; and
removing a colloid from the tube; wherein
after direction of the pulses from the ablation source to the target the colloid comprises nanostructures of the target within the first fluid.

In accordance with an embodiment of the invention there is provided a method of generating nanostructures comprising:
providing a tube;
providing a first target of a first material within the tube from which a core of the nanostructures are to be formed;
providing a second target of a second material within the tube from which a shell of the nanostructures are to be formed;
providing a first ablation source for generating pulses that ablate the first target to form initial nanostructures;
providing a second ablation source for generating pulses that ablate the second target to coat the initial nanostructures to form final nanostructures; wherein
a fluid flows through the tube such that it flows past the first target and then the second target; and
the fluid transports the generated initial nanostructures past the second target such that the generated initial nanostructures of the first material are coated over a portion of their surface with the second material.

In accordance with an embodiment of the invention there is provided a method of generating nanostructures comprising:
providing a tube;
providing a first target of a first material within the tube from which a core of the nanostructures are to be formed;
providing a first ablation source for generating pulses that ablate the first target to form initial nanostructures;
providing a second ablation source for generating pulses to fragment the initial nanostructures to form final nanostructures; wherein
a fluid flows through the tube such that it flows past the first target; and
the fluid transports the generated initial nanostructures away from the first ablation source to the second ablation source such that the generated initial nanostructures of the first material are fragmented with the second ablation source.

In accordance with an embodiment of the invention there is provided a method of generating nanostructures comprising:
providing a first reactor comprising:
   a tube;
   a first target of a first material within the tube from which a core of the nanostructures are to be formed; and
   a first ablation source for generating pulses that ablate the first target to form initial nanostructures;
providing a second reactor comprising
   another tube;
   a second target of a second material within the another tube from which a shell of the nanostructures are to be formed;
   second ablation source for generating pulses that ablate the second target to coat the initial nanostructures to form final nanostructures; wherein
an output of the first reactor is coupled to an inlet of the second reactor;
a first fluid flows through the tube such that it flows past the first target moving the generated initial nanostructures away from the first ablation source to the outlet of the first reactor;
a second fluid flows through the tube such that it flows from the inlet of the second reactor past the second target moving the final initial nanostructures away from the second ablation source; and
the second reactor coats the initial nanostructures of the first material over a portion of their surface with the second material.

In accordance with an embodiment of the invention there is provided a method of generating nanostructures comprising:
providing a tube;
providing a first target of a first material within the tube;
providing a first ablation source for generating pulses that ablate the first target;
providing a flow of nanoparticles through the tube via a fluid flowing through the tube such that it flows past the first target; wherein
the fluid transports the nanoparticles past the first target such that the nanoparticles are coated over a portion of their surface with the first material ablated from the first target.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a schematic representation of a pulsed laser ablation in fluid (PLAF) reactor for production of nanostructures in colloid according to an embodiment of the invention;

FIG. 2 depicts the absorbance spectra of gold nanoparticles showing the maximum resonance wavelength redshift with increasing temperature of the liquid within an exemplary PLAF reactor according to an embodiment of the invention;

FIG. 3 depicts a plot of resonance wavelength of the generated gold nanoparticles generated via a PLAF reactor according to an embodiment of the invention versus PLAF liquid temperature;

FIG. 4 depicts the variation of absorbance spectra of gold nanoparticles generated in an exemplary PLAF reactor at 5° C. with the time of ablation;

FIG. 5 depicts an exemplary PLAF reactor schematic for a PLAF reactor according to an embodiment of the invention for continuous production of core-shell nanoparticles via nanoscale laser ablation;

FIG. 6 depicts an exemplary PLAF reactor schematic for a PLAF reactor according to an embodiment of the invention for continuous production of small nanoparticles via nanoscale laser ablation;

FIG. 7 depicts an exemplary PLAF reactor schematic for a PLAF reactor according to an embodiment of the invention for continuous production of core-shell nanoparticles via nanoscale laser ablation; and

FIG. 8 depicts an exemplary PLAF reactor schematic for a PLAF reactor according to an embodiment of the invention for continuous production of core-shell nanoparticles via nanoscale laser ablation using a source of core nanoparticles.

### DETAILED DESCRIPTION

The present invention is direct to nanoparticles and more particularly to methods of manufacturing simple and complex nanoparticles using ablation processes.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom,” “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting” and grammatical variants thereof do not preclude the addition of one or more components, features, steps, integers or groups thereof and that the terms are not to be construed as specifying components, features, steps or integers. Likewise, the phrase “consisting essentially of,” and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “laser” as used herein and throughout this disclosure refers to, but is not limited to, a device which emits optical radiation through a process of optical amplification based upon stimulated emission. A laser, according to its design, may be operated continuously and gated to provide pulses or be pulsed. A laser may generate pulses on timescales of femtoseconds, picoseconds, nanoseconds, microseconds, milliseconds either directly by design or through the user of gating elements and/or nonlinear optical elements. A laser may operate in the ultra-violet, visible, near infrared or far infrared. A laser may be:
a gas laser, such as those exploiting helium-neon (633 nm), cardon dioxide (CO2) (10.6 μm), krypton (458 nm, 4788 nm, 514.5 nm), nitrogen (337.1 nm), helium silver (224 nm) or neon-copper (248 nm) for example;
a chemical laser powered by a chemical reaction;
an excimer laser such as ArF (193 nm), KrCl (222 nm), KrF (248 nm), XeCl (308 nm), and XeF (351 nm) for example;
a solid state laser such as yttrium orthovanadate (Nd: YVO4), yttrium lithium fluoride (Nd: YLF) and yttrium aluminium garnet (Nd: YAG) emitting at 1064 nm which may be frequency doubled or tripled;
semiconductor lasers such as those exploiting InGaN (blue-violet to green) AlGaInP or GaInP (red) for example; and
dye lasers predominantly for tunable short-duration pulses.

An “ablation source” as used herein and throughout this disclosure refers to, but is not limited to, a coherent optical source such as a laser, an incoherent optical source, a microwave source, an X-ray source, a terahertz radiation source, an electron beam, a radio frequency source, and ultrasound source which imparts sufficient energy to a localized region of a material for that localized region to ablate from the material. The ablated material may be vaporized, evaporated or sublimated and cool to form the nanoparticles, a liquid or molten droplet that cool to form the nanoparticles or solid particulates. Within some instances the ablated material is initially converted to a plasma.

A “fluid” as used herein and throughout this disclosure refers to, but is not limited to, a liquid, gas, or other material that continuously deforms (flows) under an applied shear stress, or external force.

A “nanostructure” (also referred to as an ultrafine particle or nanoparticle) as used herein and throughout this disclosure refers to, but is not limited to, a particle that is between 1 nm and 100 nm in diameter. It may refer also to larger particles, up to 500 nm, or up 1000 nm as well as nanofibers, nanowires, and nanotubes that are less than 100 nm in two or more directions. Nanostructures are usually distinguished from microparticles (1-1000 μm), “fine particles” (sized between 100 and 2500 nm), and “coarse particles” (ranging from 2500 to 10,000 nm), because their smaller size results in different physical or chemical properties, like colloidal properties and optical or electric properties, to these larger particles and/or the bulk properties of the material and/or materials the nanostructure is formed from. A nanostructure may be symmetric, non-symmetric, spherical, non-spherical, solid, hollow, be formed from a single material, be formed from multiple materials and may comprise multiple layers or shells (see below for core-shell nanostructures).

A “symmetric nanostructure” as used herein and throughout this disclosure refers to, but is not limited to, a three-dimensional nanostructure having a three-dimensional symmetry or predominantly three-dimensionally symmetric physical geometry such as cubes or spheres for example. A symmetric nanostructure may exhibit shape-dependent and size-dependent chemical and/or physical properties which are isotropic.

A “non-symmetric nanostructure” as used herein and throughout this disclosure refers to, but is not limited to, a three-dimensional nanostructure which may exhibit no symmetry or symmetry in one or two dimensions, e.g. nanoprisms, nanowires, nanofibers, nanotubes, nanorods, etc. A non-symmetric nanostructure may exhibit shape-dependent and/or size-dependent chemical and/or physical properties which may be isotropic or anisotropic.

A “nanowire” or “nanofiber” as used herein and throughout this disclosure refers to, but is not limited to, a nanostructure having a length larger than (typically referred to as a nanorod) or significantly larger (nanowire or nanofiber) than its other dimensions. The lateral dimensions perpendicular to the axis of its length being typically of nanostructure dimensions but its length may be that of nanostructures or a microparticle.

A “nanotube” as used herein and throughout this disclosure refers to, but is not limited to, a nanostructure such as a nanowire or nanorod which is hollow such that it resembles a section of a tube.

A “quantum dot” as used herein and throughout this disclosure refers to, but is not limited to, a semiconductor nanostructure where its dimensions are small enough that its optical and/or electrical properties are determined by quantum mechanics where their properties are intermediate between bulk semiconductors and discrete atoms or molecules. Their optoelectronic properties change as a function of both size and shape.

A “core-shell nanostructure” as used herein and throughout this disclosure refers to, but is not limited to, a nanostructure comprising a core of a first material or materials fully or partially surrounded by a shell of a second material or materials. The core may be solid or it may be hollow. A core-shell nanostructure may exploit a symmetric nanostructure, asymmetric nanostructure, nanorod, nanotube etc. Optionally, the shell may itself be formed from several shell layers each of different material(s) and/or material compositions. Optionally, the core may be movable within the shell. The core may be a metal, a ceramic, an insulator, a semiconductor, an inorganic material, an organic material etc. The shell may be a metal, a ceramic, an insulator, a semiconductor, a superconductor material, an inorganic material, an organic material etc. Optionally, the core may be a quantum dot, a quantum wire or comprise quantum dots and/or quantum wires.

A “metal” as used herein and throughout this disclosure refers to, but is not limited to, a material having good electrical and thermal conductivity. Metals are generally malleable, fusible, and ductile. Metals as used herein may refer to elements, such as gold, silver, copper, aluminum, iron, titanium, rhodium, etc.

An “alloy” as used herein and throughout this disclosure refers to, but is not limited to, is an admixture of metals, or a metal combined with one or more other elements. An alloy may be a solid solution of metal elements having a single phase (i.e. where all metallic grains (crystals) are of the same composition) or a mixture of metallic phases (two or more solutions, forming a microstructure of different crystals within the metal). An alloy may also refer to an intermetallic compound with a defined stoichiometry and crystal structure.

A “ceramic” as used herein and throughout this disclosure may refer to, but is not limited to, an inorganic, nonmetallic solid material comprising metal, non-metal or metalloid atoms primarily held in ionic and covalent bonds. Such ceramics may be crystalline materials such as oxide, nitride or carbide materials, elements such as carbon or silicon, and non-crystalline.

An “insulator” as used herein and throughout this disclosure may refer to, but is not limited to, an electrical insulator and/or a thermal insulator. An electrical insulator being a material or materials whose internal electric charges do not flow freely, and therefore make it difficult to conduct an electric current under the influence of an electric field.

A “conductor” as used herein and throughout this disclosure may refer to, but is not limited to, an electrical conductor and/or a thermal conductor. An electrical conductor being a material or materials allowing the flow of charge (electrical current) in one or more directions under the influence of an electric field. A thermal conductor being a material or materials allowing the transfer of internal energy by the microscopic collisions of particles and/or movement of electrons within the material(s).

A “semiconductor material” or “semiconductor” as used herein and throughout this disclosure may refer to, but is not limited to, a material having an electrical conductivity value falling between that of a conductor and an insulator which falls as its temperature rises. Its conducting properties may be altered by introducing impurities (“doping”) into the crystal structure. When two differently doped regions exist in the same crystal, a semiconductor junction is created wherein the behavior of charge carriers, which include electrons, ions and electron holes, at these junctions vary according to the electrical bias thereby allowing such junctions to function as diodes, transistors and alike. Some examples of semiconductors or semiconductors include silicon, germanium, gallium arsenide, indium phosphide, and elements near the so-called “metalloid staircase” within the periodic table.

A “superconductor” as used herein and throughout this disclosure refers to, but is not limited to, a material wherein their electrical resistance vanishes and magnetic flux fields are expelled from the material when the temperature of the material is reduced to below a critical temperature characteristic of the material. Examples of superconductors include, for example, chemical elements (e.g. mercury or lead), alloys (such as niobium-titanium, germanium-niobium, and niobium nitride), ceramics (yttrium barium copper oxide (YBCO) and magnesium diboride), superconducting pnictides (like fluorine-doped LaOFeAs (stacked layer structures) or organic superconductors such as fullerenes and carbon nanotubes.

A “polymer” as used herein may refer to, but is not limited to, is a large molecule, or macromolecule, composed of many repeated subunits. Such polymers may be natural and synthetic and typically created via polymerization of multiple monomers. Polymers through their large molecular mass may provide unique physical properties, including toughness, viscoelasticity, and a tendency to form glasses and semi-crystalline structures rather than crystals.

A “powder” as used herein may refer to, but is not limited to, a dry, bulk solid composed of a large number of very fine particles that may flow freely when shaken or tilted. Powders may be defined by both a combination of the material or materials they are formed from and the particle dimensions such as minimum, maximum, distribution etc. A powder may typically refer to those granular materials that have fine grain sizes but may also include larger grain sizes.

The generation of artificial nanostructures according to the art exploits several methods including inert gas condensation, attrition, chemical precipitation, radiolysis, ion implantation, pyrolysis and hydrothermal synthesis. However, these methods all exhibit limitations particularly for the synthesis of nanostructures with high yield and controlled dimensions and/or properties. These limitations are further amplified when considering coating processes of nanostructures to generated what are referred to a core-shell nanostructures.

Accordingly, it would be desirable to provide a manufacturing methodology suitable for production at high yield of nanostructures and core-shell nanostructures where the generated nanostructures are physically uniform (with respect to each other) with respect to the distribution of their dimensions, properties, porosity, etc.

With respect to coating processes for nanostructures to form core-shell nanostructures then within the art these have included dip/spin coating, plasma methods, and wet chemistry. Dip/spin coating and plasma methods offer advantages over wet-chemistry methods due to their intrinsic in-situ processes requiring less sample preparation, shorter production times and do not involve solvents which are ecologically hazardous.

As will be described below with respect to embodiments of the invention the inventors have established an alternate methodology based around ablation, e.g. laser ablation, where a material for the nanostructures is ablated with an ablation source, e.g. a laser. Whilst embodiments of the invention are described below are presented with respect to laser ablation it would be evident that within other embodiments of the invention alternate ablation sources may be employed without departing from the scope of the invention. Further, within embodiments of the invention employing multiple sources, e.g. one for ablation and another for fragmentation, or multiple sources for multiple ablation steps, it would be evident to one of the skill that one or more laser sources of a series of laser sources as described within other embodiments of the invention may be replaced with one or more other ablation sources. As such embodiments of the invention may employ one or more ablation sources wherein none or a subset of the ablation sources are laser sources.

Laser ablation (LA) as a physical method of generating nanostructures is known in the art and has been broadly applied and developed for the synthesis of nanostructures. The LA synthesis of nanomaterials/nanostructures can occur in different defined environments such as in vacuum, in a gaseous environment or within a liquid medium. For the former, pulsed LA in a vacuum chamber is commonly referred to as pulsed laser ablation (PLA). With respect to other processes PLA provides improved control over stoichiometry and phase composition of the nanostructures, which is particularly beneficial for complex material growth and structures such as core-shell nanostructures etc. Pulsed laser ablation in liquid (PLAL) by contrast not only provides effective control parameters for synthesis, but the liquid medium can greatly affect the morphology and structure of the nanostructures. PLAL offers a chemically simple and clean process with little or no byproduct formation, simple starting materials, and no requirements for either a catalyst or performing nanostructure fabrication at elevated temperature and/or pressure. These factors ensure production of highly pure clean surfaces which may possess high surface activity. In some instances the phase, size, and shape of nanostructures may be controlled by tuning the ablating source, e.g. laser, parameters and other factors thereby providing a one-step fabrication methodology.

However, current PLAL processes require still require innovation to address aspects such as providing for narrower distribution around the target design dimensions and increasing yield. Currently, the low productivity of PLAL limits PLAL implementation in practical and industrial fields for nanostructure formation. Accordingly, the inventors have established through their research and developments new nanostructure fabrication methodologies exploiting PLAL for nanostructures via nanosecond (ns) ablation processing, e.g. using nanosecond laser ablation. As will become evident with respect to the description below in respect of embodiments of the invention ablation provides versatility and simplicity in material processing allowing the generation of nanostructures and core-shell nanostructures with a wide range of materials and material combinations through a process with lower complexity than the traditional chemical methods of nanostructure formation.

Within the follow description embodiments of the invention are described and depicted with respect to laser ablation processes, laser processing system, etc. However, it would be understood by one of skill in the art that the ablation source may be different within other embodiments of the invention without departing from the scope of the invention. For example, the ablation source may be a visible laser, an ultraviolet laser, an infra-red laser, a frequency doubled or tripled laser etc. Alternatively, the ablation source may be an incoherent optical source, a microwave source, an X-ray source, a terahertz radiation source, an electron beam, a radio frequency source, or an ultrasound source etc. without departing from the scope of the invention.

Within the follow description embodiments of the invention are described and depicted with respect to a liquid medium within which the ablated nanostructures form a colloid. However, it would be understood by one of skill in the art that the liquid may be a mixture of liquids, a gas, a mixture of gases or any fluid within other embodiments of the invention without departing from the scope of the invention.

Within the prior art research efforts have been yielded an improved understanding of the factors affecting the formation mechanism of nanostructures from ablated materials and laser ablated materials. Within the prior art is has been shown that nanostructures dimensions and hence its colloidal and/or material properties can be controlled by tuning the ablation source, e.g. laser, parameters such as laser fluence and wavelength as well as by changing the focusing conditions. The laser ablation process may be strongly related to the physical properties of both the target being ablated, typically a solid target although it may be a powder, particulates, etc., and the surrounding liquid or fluid. The effect of liquid physical properties on the quality of the laser synthetized colloid particles has to date not been an area of substantial research.

However, when a laser beam is focused on the material target through a liquid, the high intensity of the laser source within the focal volume may induce plasma formation resulting in laser radiation being partly absorbed by the liquid. This energy transferred to the liquid is mainly dissipated as heat. Accordingly, focusing the laser source through the liquid onto the surface of a solid target increases the liquid temperature locally and over time throughout the volume of the liquid. Additionally, the produced colloidal nanostructures in the vicinity of the laser pathway absorb and scatter the incident radiation causing further additional heating of the liquid. As a variation of the liquid temperature results in a change of its viscosity or compressibility this impacts the nanostructure generation mechanism and the properties of the nanostructures, i.e., resulting in high dispersity (formally known as polydispersity). Accordingly, improvements in the design and implementation of a PLAL for improved temperature control during the process of laser ablation in liquids should contribute to the production of nanostructures in liquid confinement with a higher quality.

Typically, short duration pulsed ablation sources, e.g. short duration pulsed lasers, are employed to achieve the nanostructure ablation. These being nanosecond pulsed lasers and ultrashort pulse lasers (also known as femtosecond lasers or picosecond lasers). A nanosecond pulsed laser typically emits pulses with a duration between 1-100 nanoseconds (ns) whilst an ultrashort pulsed laser emits pulses with a duration between 1 femtosecond (fs) and 10 picoseconds (ps). Repetition rates from a lower range of approximately 100 kHz up to tens of MHz can be achieved according to the design of the laser and the means of generating the pulses either integral within the laser's design or externally. An advantage of nanosecond pulsed lasers are their high power and high ablation rates but the longer pulse lengths result in the generation of increased heating within the target material relative to the heating from the ultrafast pulsed lasers with significantly shorter pulse durations (one or more orders of magnitude). Accordingly, the resulting increased heating affects not only the quality of synthetized particles but also the atomic species evaporated by the nanosecond pulsed laser ablation as the hotter ablated materials can react with the liquid within the PLAL system to form undesired materials, such as oxides or hydroxides where water is the liquid or carbonates when organic liquids are employed. Employing inert fluids such as inert gases etc. is complex and expensive relative to the cost and handling of a liquid which automatically results in a colloidal suspension eliminating the formation of this from the ablated materials carried by a gas. This high heat from the substrate or the pulsed laser source absorbed by the liquid may also result in decomposition of the liquid, and particularly generate ligands to react with the target materials.

It has been shown in the prior art that temperature variations of water within a PLAL system influences the hydrodynamic diameter of the resulting colloidal nanostructures when a gold target was ablated by an infrared femtosecond laser in water at different stabilized liquid temperatures, ranged from of 10 to 80° C. Viscosity and compressibility of the liquid change with the temperature and affect the nanostructures generation mechanism.

Compared to laser ablation with pulses of longer duration, e.g. nanoseconds, with irradiation of metal targets by femtosecond laser pulses the heat effect is reduced as the femtosecond laser pulses release energy to electrons in the target on a time-scale much faster than electron-phonon thermalization processes with nanosecond laser pulses. Accordingly, within the prior art femtosecond pulsed lasers are employed, described and recommended for ablation relative to nanosecond pulsed lasers as they are able to eliminate some issues related with the use of nanosecond lasers for laser ablation.

Accordingly, PLAL methods involving the use of a femtosecond (ultrafast laser) laser have emerged as the dominant and preferred approach in the prior art for the mass production of nanostructures colloid solutions with a reduced average size and a narrow size distribution. Within these prior art methods, a high repetition rate of greater than 100 kHz was used as the lasers employed were designed for high repetition rates. However, this direct application of a high repetition rate pulsed laser in laser ablation as a method of producing nanostructures has several drawbacks. When ablation is performed in a liquid solvent at a repetition rate greater than 100 kHz the accumulative heating of the liquid solvent becomes an issue. Further, at a repetition rate greater than 1 MHZ, the pulse energy will be limited due to limited total power of the laser. Additionally, to improve productivity complex and expensive optics, such galvanometer-based mirror or polygonal mirror-based scanners for example. Accordingly, additional complexity in the manufacturing system allows for solving what is referred to as cavitation bubble shielding with high repetition rate femtosecond lasers where cavitation bubbles within the liquid scatter or deflect the laser beam effectively shielding the target.

However, it would be beneficial to provide a method of ablation-based nanostructure manufacturing that exploits nanosecond pulsed lasers to provide nanostructures and nanostructures of a controlled size and low polydispersion in a liquid solvent to enhance production efficiency and lower manufacturing costs.

Within the following embodiments of the invention the systems described are referred to as pulsed laser ablation in fluid (PLAF) systems as they employ a fluid which may be a liquid, a gas, or a combination thereof.

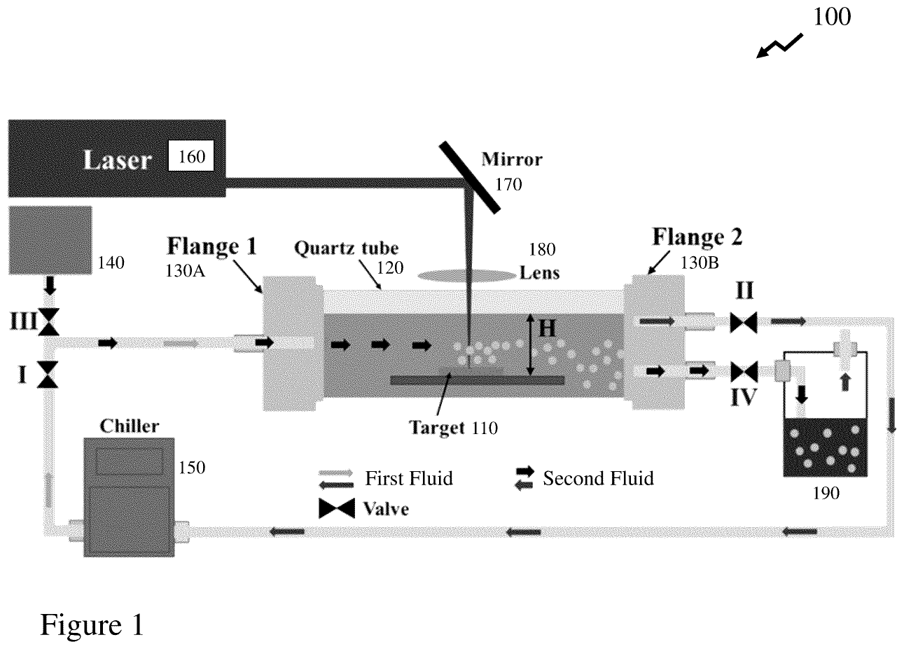

Referring to FIG. 1 there is depicted a schematic representation of a pulsed laser ablation in fluid (PLAF) reactor 100 for production of nanostructures in colloid according to an embodiment of the invention. As depicted a Target 110 from which the nanostructures are to be ablated is disposed within a Tube 120, e.g., a Quartz tube, having an Input Flange 130A and an Output Flange 130B. The Input Flange 130A is connected by a Valve I to the output of a Chiller 150 which circulates a first fluid source, e.g., a first fluid, deionized water or a solvent, into the Tube 120 via the Input Flange 130A and receives it back via Valve II from the Output Flange 130B. The Input Flange 130A is also connected via Valve III to a second fluid source, e.g., a second fluid, air or nitrogen, from Source 140. The Output Flange 130B is also coupled to Valve IV wherein the fluid with nanostructures (nanostructure colloid for example) is coupled to a Tank 190 wherein the nanostructures are stored for subsequent use. Excess fluid from the Tank 190 is depicted as being disposed of although potentially within other embodiments of the invention the outlet of the Tank 190 may loop back as part of the overall recirculating system of the PLAF reactor 100.

Within another embodiment of the invention the second fluid source may be recirculated as is the first fluid source.

Within another embodiment of the invention the second fluid source may be temperature controlled as is the first fluid source.

Within another embodiment of the invention a second fluid from the second fluid source may be same as a first fluid from the first fluid source.

Within another embodiment of the invention the Chiller 150 may provide a temperature-controlled fluid source providing the fluid to the Tube 120 at an elevated temperature.

Accordingly, in operation the Target 110 is disposed within the Tube 120 and the output of a pulsed nanosecond laser, Laser 160, is directed and focused onto the target via intermediate optics, such as Mirror 170 and Lens 180 for example although other optical trains between the Laser 160 and the Target 110 may be employed without departing from the scope of the invention. For example, the optical train may employ microprocessor controlled scanning elements to provide a defined pattern of incident laser source with time, an element to generate multiple beams from a single laser for parallel concurrent nanostructure fabrication etc. Within another embodiment of the invention the Laser 160 may be multiple lasers having either common characteristics such as emission wavelength, pulse width, pulse rate, output power etc. of different common characteristics such as emission wavelength, pulse width, pulse rate, output power etc.

The depth of the fluid above the Target 110 can be adjusted according to the operation of the PLAF reactor 100 in dependence upon the geometry of the Tube 120, the volume of fluid(s) pumped into the Tube 120, etc. Typical depths may range from a millimeter or several millimeters to several centimeters.

The Laser 160 operates at a predetermined repetition rate established in dependence upon one or more factors including, but not limited to, the material of the Target 110, one or more dimensions of the nanostructures being fabricated, the geometry of the of the nanostructures being fabricated, and output power of the laser. A repetition rate may be above 1 Hz, above 10 Hz, above 100 Hz, above 1 kHz, above 10 kHz or above 100 kHz. For example, repetition rate may be within the range 1 Hz to 100 Hz. The repetition rate may be between 5 Hz to 20 Hz. Optionally, the Laser 160 may have a fixed pulse repetition rate, or it may have variable pulse repetition rate allowing this to be dynamically controlled.

The Laser 160 operates at a predetermined pulse duration rate which may be for example established in dependence upon one or more factors including, but not limited to, the material of the Target 110, one or more dimensions of the nanostructures being fabricated, the geometry of the of the nanostructures being fabricated, and output power of the laser. Optionally, the Laser 160 may have a fixed pulsed duration, or it may have variable pulse duration allowing this to be dynamically controlled. A pulse duration may be greater than Ins, greater than 10 ns, or greater than 100 ns. The pulse duration may for example be between 4 ns and 25 ns.

The Laser 160 operates at a predetermined pulse energy which may be established for example in dependence upon one or more factors including, but not limited to, the material of the Target 110, one or more dimensions of the nanostructures being fabricated, the geometry of the of the nanostructures being fabricated, and output power of the laser. Optionally, the Laser 160 may have a fixed pulsed energy or it may have variable pulse energy allowing this to be dynamically controlled. A pulse energy may be greater than 50 mJ, 10 mJ, greater than 100 mJ, or greater than 1 J. The pulse energy may for example be between 50 mJ to 800 mJ. The pulse energy may be between 80 mJ and 200 mJ.

The relative positions of the Target 110 and the intermediate optical train between it and the Laser 160 may be adjusted to establish a predetermined laser fluence which may for example be established in dependence upon one or more factors including, but not limited to, the material of the Target 110, one or more dimensions of the nanostructures being fabricated, the geometry of the of the nanostructures being fabricated, and output power of the laser. The laser fluence may be greater than 100 mJ/cm2, greater than 1 J/cm2, great than 10 J/cm2 or greater than 100 J/cm2. The laser fluence may be between 1 J/cm2 and 80 J/cm2. The laser fluence may be between 10 J/cm2 and 40 J/cm2.

Within embodiments of the invention the recirculating fluid, provided via Valve I to the Input Flange 130A, e.g. water, may be deionized water, a different grade of water, an organic liquid, an organic solvent, an inorganic liquid, an inorganic liquid, a gas, or a combination of these.

Within embodiments of the invention the recirculating fluid, provided via Valve I to the Input Flange 130A, may not contain a reducing agent, an oxidizing agent, a deflocculant or a surfactant. Within embodiments of the invention the recirculating fluid, provided via Valve I to the Input Flange 130A, may contain one or more reducing agents, one or more oxidizing agents, one or more deflocculants or one or more surfactants or a combination of these.

As outlined above the PLAF reactor 100 as depicted according to an embodiment of the invention has two flanges, Input Flange 130A and Output Flange 130B, on either end of the Tube 120. Within other embodiments of the invention these flanges may be disposed on one end of the Tube 120, on one or more sides of the Tube 120 or an end and side of the Tube 120 etc. without departing from the scope of the invention. Optionally, the flanges may be combined within a common flange. The Chiller 150 circulates the liquid with a controlled temperature (e.g. between 2° C. and 100° C. from one flange, Input Flange 130A to Output Flange 130B when Valve I and Valve II are open with Valve III and Valve IV closed.

As outlined above the PLAF reactor 100 as depicted according to an embodiment of the invention has Input Flange 130A has a common inlet port for the recirculating liquid from the Chiller 150 via Valve I and the second fluid from the Source 140 via Valve III. Within other embodiments of the invention the Chiller 150 and Source 140 may be connected to the Tube 120 via different ports of the same flange or different flanges. The second fluid from the Source 140 may for example be a gas such as compressed air, an inert gas such as nitrogen or argon, a reactive gas providing an oxidizing environment such as oxygen for generating oxide nanostructures from a target material, or a reducing environment. Within other embodiments of the invention the second fluid from Source 140 may be a combination of gases, a liquid or a combination of liquids.

Within PLAF reactor 100 the Output Flange 130B is depicted with two outlets, one coupled to Valve II and therein the Chiller 150 and the other via Valve IV to the Tank 190. Accordingly, the Tube 120 may be filled and the nanostructures manufactured after which the nanostructures, e.g. within a colloidal suspension, are coupled to the Tank 190 and other liquid extracted via opening Valves III and IV whilst closing Valves I and II. Optionally, the output from the Output Flange 130B is only to the Tank 190 wherein excess fluid is removed from the Tank 190.

Within other embodiments of the invention Valve I and Valve IV or Valve III and Valve II, or Valves I, II, III and IV are open such that the nanostructures once formed are removed from the Tube 120.

Within embodiments of the invention the output from the PLAF reactor 100 may be filtered prior to the Tank 190 to separate excess liquid or upon extraction from the Tank 190 etc. Optionally, Tank 190 may comprise one or more other stages of processing the output from the PLAF reactor 100 such as a mechanical process, a physical process, an electro-chemical process, a chemical process of a combination thereof.

Within embodiments of the invention the output from the PLAF reactor 100 may be processed for transfer to one or more other processing stages prior to the fabricated nanostructures being employed or they may be transferred to one or more further processing stages for direct deployment and use of the fabricated nanostructures.

Optionally, the second fluid may be immiscible with the first fluid or it may be miscible with the first fluid. Within embodiments of the invention only the first fluid may be employed, e.g. the second fluid is omitted. Within embodiments of the invention the first fluid source may employ a first fluid which is inert with respect to the ablation process and the material of the Target 110. Within another embodiment of the invention the first fluid may act as a catalyst in conjunction with the Laser Source 160 to enhance or trigger the ablation process from the Target 110. Within embodiments of the invention the second fluid from the Source 140 may be employed to flush the Tube 120 or it may be employed in conjunction with the first fluid. The second fluid and first fluid may be inert with respect to one another or they may react together discretely or in the presence of the material of the Target 110 to enhance or trigger the ablation process from the Target 110.

Within embodiments of the invention the output(s) from the PLAF reactor 100 may be adjustable in position to one or either of the Valve II and Valve IV. These may be moved together or independently in dependence upon or independent from the depth of the fluid (H) within the Tube 120.

Within embodiments of the invention the first fluid source from Chiller 150 and/or the second fluid source from Source 140 may flow through the Tube 120 in order to remove the produced nanostructures from the laser trajectory, thereby reducing the scattering and absorbing effect of these nanostructures and improving the production rate.

Whilst not depicted in PLAF reactor 100 temperature sensors disposed with respect to the PLAF reactor 100 provide a feedback loop such that the temperature of the fluid is dynamically controlled by a continuous fluid circulation via Chiller 150 or through other means disposed with respect to the PLAF reactor 100. Accordingly, fine control of the temperature range of the fluid can be achieved under closed loop feedback of the temperature and/or one or more other sensors determining characteristics and/or dimensions of the as fabricated nanostructures both to adjust the overall fluid temperature and also compensate for heat transfer between the target and/or laser beam and the fluid.

Within other embodiments of the invention an ablation source other than a laser source may be employed within a reactor, such as PLAF reactor 100, to generate nanoparticles without departing from the scope of the invention.

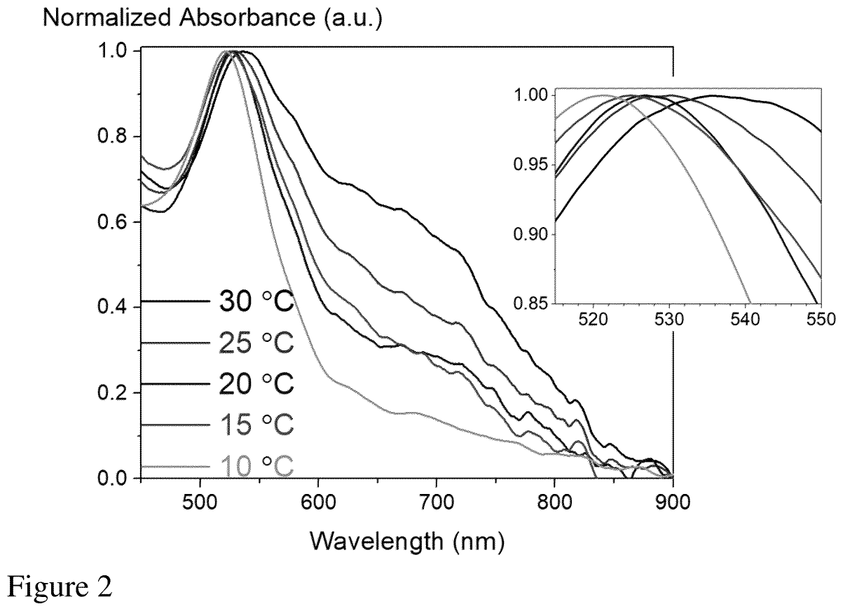

Referring to FIG. 2 there us depicted a plot of the absorbance spectra of gold nanoparticles showing a redshift in the maximum resonance wavelength with increasing temperature of the fluid, in this instance deionized water, within an exemplary PLAF reactor according to an embodiment of the invention. This being clearly evident in the inset depicted the peak region. Variations in the temperature of the fluid induce changes in the nanoparticles size and size distribution.

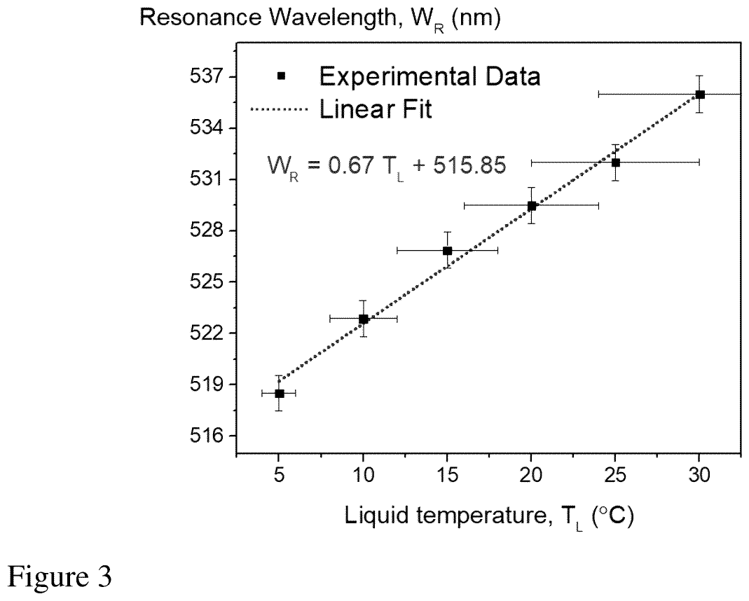

Now referring to FIG. 3 there is depicted a plot of resonance wavelength of the generated gold nanoparticles generated via a PLAF reactor according to an embodiment of the invention versus PLAF liquid temperature according to the results used to also provide FIG. 2. Accordingly, the wavelength of the resonance surface plasmon redshift (W_{R}) with liquid temperature (T_{L}) can be described by a linear fit. In this manner, measurement of the redshift can also be used to provide feedback to the PLAF reactor to adjust the temperature of the fluid.

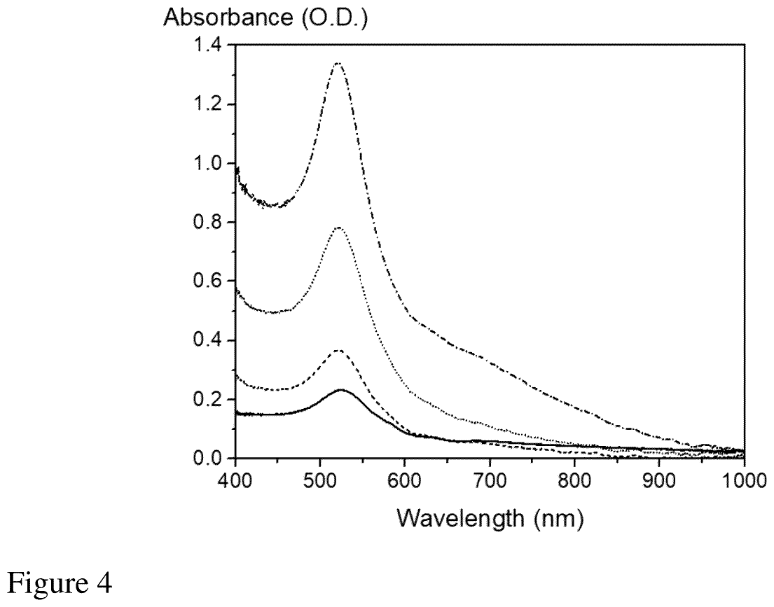

The exemplary PLAF reactor as depicted in FIG. 1 contributes to maintaining a high production rate of the nanostructures with ablation time. FIG. 4 depicts the variation of absorbance spectra of gold nanoparticles generated in the exemplary PLAF reactor 100 at 5° C. at different time points within continuous operation of the PLAF reactor over a period of 3 hours.

Within reactors as described above in respect of PLAF reactor 100 in FIG. 1 and below in respect of PLAF reactors 500, 600, 700, and 800 in FIGS. 1 and 5-8 respectively the temperature of the fluid within the vicinity of the target may be established in dependence upon a characterisation of the ablated nanoparticles formed at different fluid temperatures where the set point temperature of the fluid is adjusted in order to establish the desired characteristic of the ablated nanoparticles. Such characteristics may include, but not be limited to, absorption wavelength, nanoparticle dimension, nanoparticle density, nanoparticle porosity, and nanoparticle composition (where the target is an alloy, ceramic, etc. rather than a single atomic species) for example.

Within reactors as described above in respect of PLAF reactor 100 in FIG. 1 and below in respect of PLAF reactors 500, 600, 700, and 800 in FIGS. 1 and 5-8 respectively an aspect of the fluid within the vicinity of the target may be established in dependence upon a characterisation of the ablated nanoparticles formed at different fluid aspect settings where the set point temperature of the fluid is adjusted in order to establish the desired characteristic of the ablated nanoparticles. The aspect settings may include, but not be limited to, pressure, flow rate, flow rate profile (e.g., the flow rate may vary with time in smoothly varying, linear profile or non-linear profile) for example as well as the actual fluid employed and/or the fluid's temperature. A varying flow rate may, for example, result in low flow for a period of time followed by a higher flow such that low flow is a nanoparticle formation portion of a cycle and the higher flow rate is a sweeping portion of the cycle to remove the fabricated nanoparticles from above the target rather than a simple continuous flow rate.

Within embodiments of the invention time varying properties of the laser pulses such as intensity, duration, position etc. may be employed to generate specific nanostructure geometries. Whilst within the prior art the sequence of pulses is consistent embodiments of the invention may exploit optical techniques to generate complex pulse sequence with each “macro-pulse” which then is repeating. The individual pulses of each pulse sequence of the macro-pulse may be generated by the same laser or they may be generated by different lasers. These optical techniques may exploit, but not be limited to, optical delay lines, optical gates, optical logic elements, and non-linear optical elements.

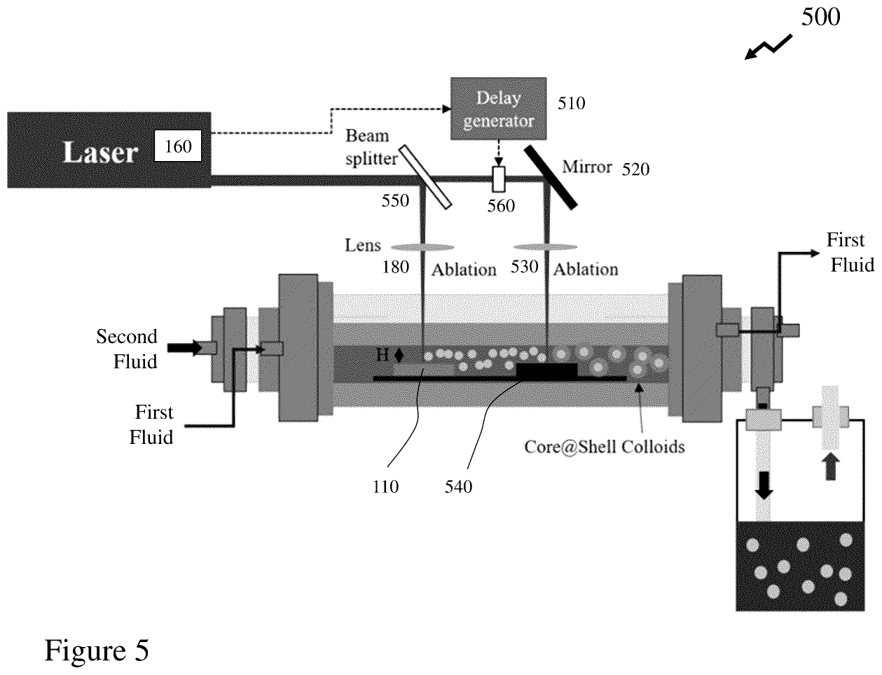

The technique depicted in FIG. 1, with exemplary PLAF reactor 100, may be extended as depicted in FIG. 5 to provide an exemplary PLAF reactor 500 according to an embodiment of the invention for continuous production of core-shell nanoparticles via nanoscale laser ablation. Exemplary PLAF reactor 500 is depicted absent some elements that have been described and depicted with respect to exemplary PLAF reactor 100 for the sake of clarity or these elements may be omitted within other embodiments of the invention. As depicted the PLAF reactor 500 comprises the Target 110, Laser 160 and Lens 180 but the mirror is now replaced with a Beamsplitter 550 such that a portion of the output from the Laser 160 is coupled via the Lens 10 to the Target 110 whilst the remainder is coupled to a Second Target 540 via a Delay Element 560, Mirror 520 and Second Lens 530. The Delay Element 560 being coupled to a Delay Generator 510 which is optionally coupled to the Laser 510 to receive data relating to the operation of the Laser 160.

Accordingly, the first portion of the output of the Laser 160 generates an initial nanostructure, e.g. what will be the core of a core-shell nanostructure, which as it “flows” through the PLAF reactor 100 is then coated fully or partially with the Second Target 120 to form the shell of the core-shell nanostructure through ablation of the Second Target 540. As a result a colloid of core-shell nanostructures is formed.

It would be evident that this sequence can be extended such that nanostructures with multiple shells around a core are formed.

It would be evident that this sequence can be extended such that nanostructures with multiple cores of dissimilar materials are encased with one of more shells are formed.

Optionally, the Delay Element 560 and Delay Generator 560 are replaced with a fixed delay optical path. However, with a controllable Delay Element 560 the delay between ablating the Target 110 and Second Target 540 may be adjusted in dependence upon the flow of the fluid within the PLAF reactor 500.

Optionally, two lasers which are synchronized may be employed to provide the two beams for ablating the Target 110 and Second Target 540. These may, for example, be the same type of laser with common output power, repetition rate, pulse duration etc., the same type of laser with different characteristics such as output powers, repetition rates, pulse durations, operating wavelength etc., or different lasers with different characteristics such as output powers, repetition rates, pulse durations, operating wavelength etc. according to the requirements of the core-shell nanostructures including, but not limited, the material of Target 110, material of Second Target 540, geometry of the nanostructures, etc. Within embodiments of the invention the core may be formed with a nanosecond laser with the shell formed from the same or another nanosecond laser. Within other embodiments as femtosecond lasers can generate plumes of vaporized material rather than nanostructures per se a nanosecond laser may be employed for forming the core of a core-shell nanostructure whilst a femtosecond laser is employed for forming the shell of the core-shell nanostructure.

Within embodiments of the invention multiple subsequent ablations of the first Target 110 may be employed to achieve the desired volume of nanoparticles, which form the core of the core-shell nanostructures.

Within embodiments of the invention multiple subsequent ablations of the second Target 540 may be employed to achieve the desired coverage and/or thickness of the shell of the core-shell nanostructures.

Within embodiments of the invention multiple second Targets 540 may be deployed each formed from a different material, allowing a core-multiple shell nanostructures to be formed. For example, with two subsequent targets, e.g.

Compared with other existing methods for generating core-shell nanostructures the PLAF reactor 500 provides a simple in situ method which is compatible with a wide range of materials for the core(s) and shell(s).

Within other embodiments of the invention an ablation source other than a laser source may be employed within a reactor, such as PLAF reactor 500, to generate nanoparticles without departing from the scope of the invention. Where two sources are employed one or more of these may be an ablation source other than a laser source.

As depicted PLAF reactor 500 is supplied with a first fluid and a second fluid. Optionally, the second fluid may be immiscible with the first fluid or it may be miscible with the first fluid. Within embodiments of the invention only the first fluid may be employed, e.g. the second fluid is omitted. Within embodiments of the invention the first fluid source may employ a first fluid which is inert with respect to the ablation processes and the materials of the first Target 110 and second Target 540. Within another embodiment of the invention the first fluid may act as a catalyst in conjunction with the Laser Source 160 to enhance or trigger the ablation process from the first Target 110 and/or the ablation process from the second Target 540. Within embodiments of the invention the second fluid from the Source 140 may be employed to flush the Tube 120 or it may be employed in conjunction with the first fluid. The second fluid and first fluid may be inert with respect to one another or they may react together discretely or in the presence of the material of the first Target 110 and/or second Target 540 to enhance or trigger the ablation process from the first Target 110 and/or the second Target 540.

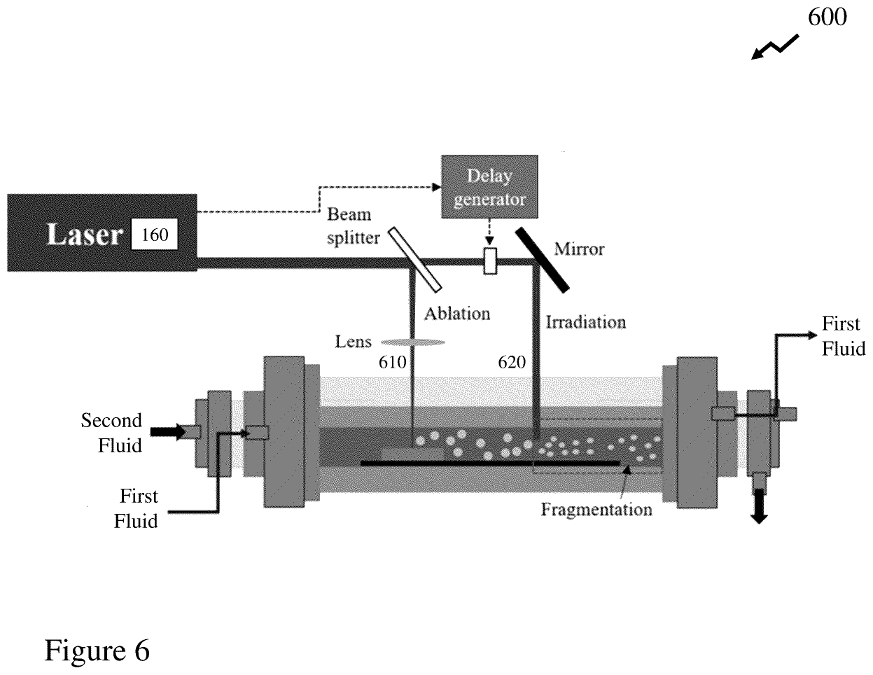

Referring to FIG. 6 there is depicted an exemplary PLAF reactor schematic for a PLAF reactor 600 according to an embodiment of the invention for continuous production of small nanoparticles via nanoscale laser ablation. Whilst depicted with an optical configuration similar to that of PLAF reactor 500 in FIG. 5 the PLAF reactor 600 has a single target wherein the first Beam 610 generates nanostructures and the second Beam 620 fragments the nanostructures generated from the first Beam 610. The second Beam 620 may be focused differently to the first Beam 610 as the requirement is not to ablate material but fragment or break condensed nanostructures apart. This method provides additional control of the morphology and the size of generated particles with the lower polydispersion.

Optionally, within other embodiments of the invention the Laser 160 generating the first Beam 610 and second Beam 620 may be two lasers to provide the two beams for ablating the Target 110 and Second Target 540. Optionally, the two laser are both pulsed and synchronized. Optionally, the laser generating the first beam is pulsed and the laser generating the second beam is continuous wave (CW). Optionally, the laser generating the beams is CW with optical gates and pulse generation elements disposed in the output to generate pulsed and CW beams.

Within embodiments of the invention the two lasers may be the same type of laser with common output power, repetition rate, pulse duration etc., the same type of laser with different characteristics such as output powers, repetition rates, pulse durations, operating wavelength etc., or different lasers with different characteristics such as output powers, repetition rates, pulse durations, operating wavelength etc. according to the requirements of initially generating the nanostructures and subsequently fragmenting them including, but not limited, the material of Target 110, geometry of the nanostructures etc.

Within other embodiments of the invention an ablation source other than a laser source may be employed within a reactor, such as PLAF reactor 600, to generate fragmented nanoparticles without departing from the scope of the invention. Where two sources are employed one or more of these may be an ablation source other than a laser source.

As depicted PLAF reactor 600 is supplied with a first fluid and a second fluid.

Optionally, the second fluid may be immiscible with the first fluid or it may be miscible with the first fluid. Within embodiments of the invention only the first fluid may be employed, e.g. the second fluid is omitted. Within embodiments of the invention the first fluid source may employ a first fluid which is inert with respect to the ablation/fragmentation process and the material of the Target 110. Within another embodiment of the invention the first fluid may act as a catalyst in conjunction with the Laser Source 160 to enhance or trigger the ablation process from the Target 110 and/or the subsequent fragmentation process. Within embodiments of the invention the second fluid from the Source 140 may be employed to flush the Tube 120 or it may be employed in conjunction with the first fluid. The second fluid and first fluid may be inert with respect to one another or they may react together discretely or in the presence of the material of the Target 110 to enhance or trigger the ablation process from the Target 110 and/or the subsequent fragmentation process.

Within other embodiments of the invention a single ablation step may be followed by multiple steps of irradiation for fragmentation where the ablation source and its emission characteristics, such as power, pulse width, pulse repetition rate, etc. are established in each step based upon the nanoparticle dimension distribution at that stage. Accordingly, for example, a lower power for a second irradiation/fragmentation step may be employed from that of a first irradiation/fragmentation step as a distribution of nanoparticles from the ablation step prior to the first irradiation/fragmentation step has been shifted down in average particle size after the first irradiation/fragmentation step and hence this smaller particle distribution is being fragmented by the second irradiation/fragmentation step.

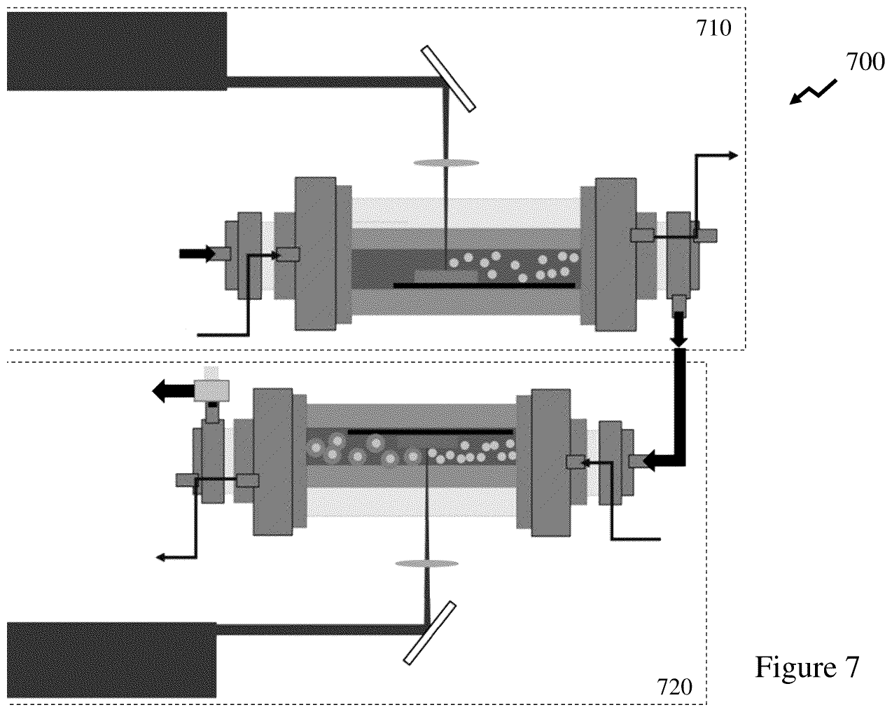

Now referring to FIG. 7 there is depicted an exemplary PLAF reactor schematic for a PLAF reactor 700 according to an embodiment of the invention for continuous production of core-shell nanoparticles via nanoscale laser ablation. In this PLAF reactor 700 the core of the core-shell nanostructures are fabricated within a first Reactor 710 whilst the shells are generated and “applied” within a second Reactor 720. Beneficially, PLAF reactor 700 relative to PLAF reactor 500 in FIG. 5 allows for fluid(s) within first Reactor 710 and second Reactor 720 to be different allowing for example for one to be inert, oxidizing or reducing in environment and the other to be inert, oxidizing or reducing in environment independent of each other based upon the requirements for the materials for the core and shell of the core-shell nanostructures respectively. Similarly, the characteristics of the lasers for the first Reactor 710 and second Reactor 720 can different or within other embodiments of the invention they may be different and/or the same laser without beam modifications or with one beam amplified/attenuated relative to the other etc.

Optionally, the scanning pattern of the first Reactor 710 to generate the core nanostructures may be different to the scanning pattern of the second Reactor 720 for generating the shell structures of the core-shell nanostructures.

Within other embodiments of the invention an ablation source other than a laser source may be employed within either one or both of first and second Reactors 710 and 720 within PLAF reactor 700 to generate core-shell nanoparticles without departing from the scope of the invention.

The fluid(s) coupled to each of the first Reactor 710 and second Reactor 720 may be as described and depicted with respect to PLAF reactor 100 in FIG. 1, i.e. the fluid(s) may be one or more of miscible or immiscible, inert or react with each other, inert or react with the target in first Reactor 710, inert or react with the target in the second Reactor 720, be different or the same.

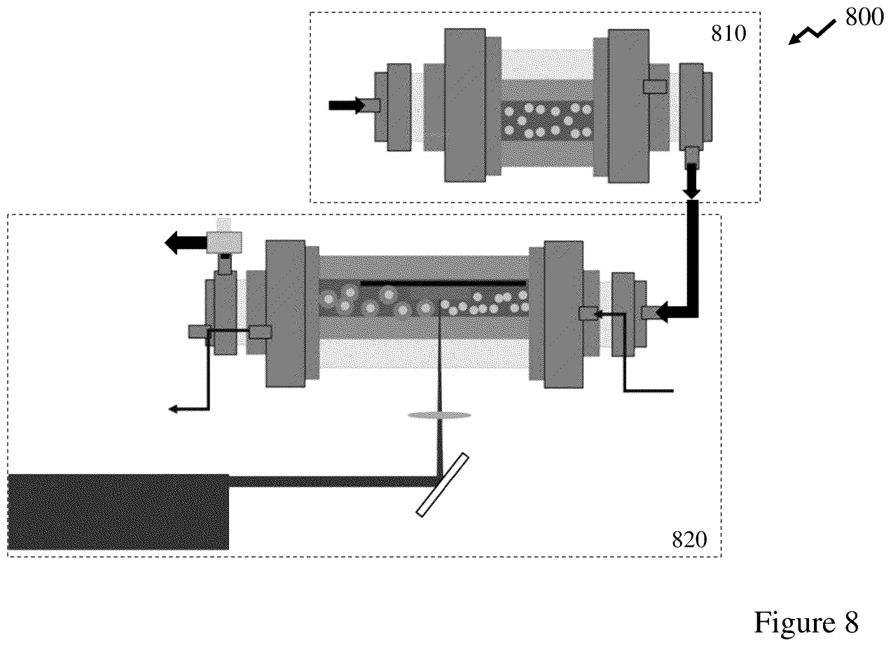

Referring to FIG. 8 there is depicted an exemplary PLAF reactor schematic for a PLAF reactor 800 according to an embodiment of the invention for continuous production of core-shell nanoparticles via nanoscale laser ablation using a source of core nanoparticles. In this a source of nanoparticles which will form the core of the core-shell nanostructures in a Vessel 810 is coupled to a Reactor 820, such as second Reactor 720 in FIG. 7 which generates the shells that are “applied” within the Reactor 820 to the core nanoparticles. In this manner the core nanoparticles may be formed or established by one or other processes such that the core nanoparticles in Vessel 810 may be inorganic or organic in composition. The core nanoparticles in Vessel 810 may be the result of employing a reactor such as PLAF reactor 100, PLAF reactor 500, PLAF reactor 600 or PLAF reactor 700 for example.

Optionally, within embodiments of the invention with respect to PLAF reactors 100, 500, 600, 700, and 800 in FIGS. 1 and 5-8 respectively whilst a single beam/reactor is depicted it would be evident that multiple beams may be employed in conjunction with a single reactor tube or that multiple beams may be employed in conjunction with multiple reactor tubes. Where multiple reactor tubes are employed these may employ one or more common fluid sources and/or recirculating systems or these may be independent.

Within embodiments of the invention a target may be a solid form of a material. Within embodiments of the invention this may be a solid piece or it may be a powder having a granularity such that it is not displaced by the fluid flow within the tube during the ablation process as described with respect to embodiments of the invention.

Within embodiments of the invention PLAF reactors 100, 500, 600, 700, and 800 in FIGS. 1 and 5-8 respectively may be employed to generate nanostructures, symmetric nanostructures, non-symmetric nanostructures, nanowires, nanotubes, quantum dots and core-shell nanostructures.

Within embodiments of the invention PLAF reactors 100, 500, 600, 700, and 800 in FIGS. 1 and 5-8 respectively may be employed to generate colloidal solutions and formulate inks with desired viscosity, concentration and solvent. In fact the fluid circulated the reactor can be modified regarding the specific ink formulations. The fluid within a reactor may within embodiments of the invention be a solvent or mixture of solvents for such colloidal solutions and inks. A solvent may include, but not be limited to, isopropanol, ethanol, acetone, and hexane for example.

Within embodiments of the invention PLAF reactors 100, 500, 600, 700, and 800 in FIGS. 1 and 5-8 respectively may be employed to generate a core of a nanostructure or a shell of a nanostructure from a metal, an alloy, a ceramic, an insulator, a conductor, a semiconductor, a superconductor, a polymer, an inorganic material or an organic material.

Within embodiments of the invention PLAF reactors 100, 500, 600, 700, and 800 in FIGS. 1 and 5-8 respectively may be employed to generate nanostructures which are then modified within the fluid within the PLAF reactor through one or more of an oxidation process, reduction process, a chemical process, an encapsulation process and a physical process.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of generating nanostructures comprising:
providing a tube;
providing a target within the tube from which the nanostructures are to be formed;
providing an ablation source for generating pulses that ablate the target to form the nanostructures;
providing a first fluid within the tube;
directing the pulses from the ablation source to the target; and
removing a colloid from the tube; wherein
after direction of the pulses from the ablation source to the target the colloid comprises nanostructures of the target within the first fluid.

2. The method according to claim 1, wherein
the first fluid is a liquid; and
the first fluid and generated nanoparticles form at least one of a colloidal solution and a colloidal ink.

3. A method of generating nanostructures comprising:
providing a tube;
providing a first target of a first material within the tube from which a core of the nanostructures are to be formed;
providing a second target of a second material within the tube from which a shell of the nanostructures are to be formed;
providing a first ablation source for generating pulses that ablate the first target to form initial nanostructures;
providing a second ablation source for generating pulses that ablate the second target to coat the initial nanostructures to form final nanostructures; wherein
a fluid flows through the tube such that it flows past the first target and then the second target; and
the fluid transports the generated initial nanostructures past the second target such that the generated initial nanostructures of the first material are coated over a portion of their surface with the second material.

4. The method according to claim 3, wherein
the first fluid is a liquid; and
the first fluid and the final nanostructures form at least one of a colloidal solution and a colloidal ink.

5. The method according to claim 3, wherein
the final nanostructures are core-shell nanostructures.

6. A method of generating nanostructures comprising:
providing a tube;
providing a first target of a first material within the tube from which a core of the nanostructures are to be formed;
providing a first ablation source for generating pulses that ablate the first target to form initial nanostructures;
providing a second ablation source for generating pulses to fragment the initial nanostructures to form final nanostructures; wherein
a fluid flows through the tube such that it flows past the first target; and
the fluid transports the generated initial nanostructures away from the first ablation source to the second ablation source such that the generated initial nanostructures of the first material are fragmented with the second ablation source.

7. The method according to claim 6, wherein
the first fluid is a liquid; and
the first fluid and the final nanostructures form at least one of a colloidal solution and a colloidal ink.

8. The method according to claim 6, wherein
the final nanostructures are core-shell nanostructures.

9. A method of generating nanostructures comprising:
providing a first reactor comprising:
a tube;
a first target of a first material within the tube from which a core of the nanostructures are to be formed; and
a first ablation source for generating pulses that ablate the first target to form initial nanostructures;
providing a second reactor comprising
another tube;
a second target of a second material within the another tube from which a shell of the nanostructures are to be formed;
second ablation source for generating pulses that ablate the second target to coat the initial nanostructures to form final nanostructures; wherein
an output of the first reactor is coupled to an inlet of the second reactor;
a first fluid flows through the tube such that it flows past the first target moving the generated initial nanostructures away from the first ablation source to the outlet of the first reactor;
a second fluid flows through the tube such that it flows from the inlet of the second reactor past the second target moving the final initial nanostructures away from the second ablation source; and
the second reactor coats the initial nanostructures of the first material over a portion of their surface with the second material.

10. The method according to claim 9, wherein
the second fluid is a liquid; and
the second fluid and the final nanostructures form at least one of a colloidal solution and a colloidal ink.

11. The method according to claim 9, wherein
the final nanostructures are core-shell nanostructures.

12. A method of generating nanostructures comprising:
providing a tube;
providing a first target of a first material within the tube;
providing a first ablation source for generating pulses that ablate the first target;
providing a flow of nanoparticles through the tube via a fluid flowing through the tube such that it flows past the first target; wherein
the fluid transports the nanoparticles past the first target such that the nanoparticles are coated over a portion of their surface with the first material ablated from the first target.

13. The method according to claim 12, wherein
the first fluid is a liquid; and
the first fluid and the final nanostructures form at least one of a colloidal solution and a colloidal ink.

14. The method according to claim 12, wherein
the nanostructures are core-shell nanostructures;
the core of the core-shell nanostructures is a nanoparticle; and
the shell of the core-shell nanostructures is formed from the first material.

15. The method according to claim 12, wherein
the nanoparticles are organic.
